(19) United States
(12) Patent Application Publication
(10) Pub. No.: US 2019/0285945 A1
(43) Pub. Date: Sep. 19, 2019

(54) LIGHTING DEVICE AND DISPLAY DEVICE INCLUDING THE SAME

(71) Applicant: SHARP KABUSHIKI KAISHA, Osaka (JP)

(72) Inventors: YOUZOU KYOUKANE, Sakai City (JP); HISASHI WATANABE, Sakai City (JP); HIROTOSHI YASUNAGA, Sakai City (JP)

(21) Appl. No.: 16/297,327

(22) Filed: Mar. 8, 2019

(30) Foreign Application Priority Data
Mar. 15, 2018 (JP) 2018-048034

(51) Int. Cl. G02F 1/1335

(52) U.S. Cl. CPC G02F 1/133603; G02F 1/133606; G02F 1/133611; G02F 1/133605

(57) ABSTRACT

A lighting device includes: a board on which a plurality of light emitting elements is arranged in a matrix; and a reflection sheet provided on the board. The reflection sheet has a plurality of apertures that is each superimposed on a corresponding one of the plurality of light emitting elements. The reflection sheet is extended in a predetermined specific extending direction. A protrusion part is provided on the board so as to protrude through the reflection sheet. The protrusion part is integrally formed with the board.

### CROSS-REFERENCE TO RELATED APPLICATION

The present application claims priority under 35 U.S.C. § 119(a) to Japanese Patent Application No. 2018-048034 filed on Mar. 15, 2018, the entire contents of which are incorporated herein by reference.

### BACKGROUND OF THE INVENTION

### Field of the Invention

The present invention relates to a lighting device such as a backlighting device, and a display device including the same.

### Description of the Related Art

Lighting devices such as a backlighting device typically include so-called edge-lit type devices and so-called direct-lit type devices. In the edge-lit type device, a light guiding panel is provided behind a display element such as a liquid crystal panel, and a plurality of light emitting elements such as light emitting diodes (LEDs) is arranged along the edge of the light guiding panel. Light is emitted from the light emitting elements through the light guiding panel and illuminates the slim display element entirely and uniformly. In the direct-lit type device, a plurality of light emitting elements is arranged behind a display element. Light is emitted from the light emitting elements behind the display element and illuminates the display element entirely and uniformly. The edge-lit lighting device can decrease its thickness by making the light guiding panel thinner, however, such a structure deteriorates the image quality in respect of luminance, contrast and the like.

In contrast, the direct-lit lighting device is mainly adopted to products that seek for high luminance and high contrast, such as televisions and digital signage devices, by controlling the amount of light emitted from the light emitting elements individually or for each region (known as local dimming control). Recently, the use of the direct-lit lighting devices has expanded to in-vehicle compact display devices that operate under a wide range of temperature environments.

The direct-lit lighting devices can improve the image quality in respect of luminance, contrast and the like thanks to the local dimming control. However, in order to operate the direct-lit lighting devices under a specific high-temperature environment, there remain the following problem.

FIGS. 23 to 30 are explanatory views for describing the problem in using a conventional direct-lit lighting device 5 under a specific high-temperature environment. FIG. 23 is a schematic cross-sectional view illustrating the conventional direct-lit type lighting device 5. FIG. 24 is a schematic cross-sectional view illustrating a configuration in which light L is diffused by a diffuser panel 6 and a reflection sheet 4 of the lighting device 5 shown in FIG. 23. FIG. 25 is a schematic perspective view illustrating one example in which the reflection sheet 4 is provided on a board 2 on which a plurality of light emitting elements 1 is arranged in a matrix. FIG. 26 is a schematic cross-sectional view illustrating a distance D between each rim 3a of a corresponding aperture 3 in the reflection sheet 4 and the light emitting element 1. FIG. 27 is a schematic cross-sectional view illustrating the positional relationship between the aperture 3 and the reflection sheet 4 in the initial state. FIG. 28 is a distribution map indicating a luminance distribution of the lighting device 5 in the initial state. FIG. 29 is a schematic cross-sectional view illustrating the positional relationship between the aperture 3 and the reflection sheet 4 after the lighting device is left under a high-temperature environment. FIG. 30 is a distribution map indicating a luminance distribution of the lighting device 5 after the lighting device is left under a high-temperature environment. In FIGS. 27 and 29, the diffuser panel 6 is omitted. FIGS. 28 and 30 indicate that the luminance decreases as the density decreases.

As shown in FIGS. 23 to 25, the conventional direct-lit lighting device 5 includes: a board 2 on which a plurality of light emitting elements 1 such as LEDs is arranged in a matrix; and a reflection sheet 4 provided on a surface of the board 2 on which the light emitting elements 1 are mounted. In the reflection sheet 4, a plurality of apertures 3 is formed so as to expose, individually, the plurality of light emitting elements 1. The lighting device 5 also includes a diffuser panel 6 that is formed so as to face the surface of the board 2 on which the light emitting elements 1 are mounted. A white resist 2a (specifically, white ink) is applied onto the board 2. In order to further improve the efficiency in the use of the light L, the reflection sheet 4 is provided on the board 2 coated with the white resist 2a. The reflection sheet 4 has a white reflection surface 4a that exhibits excellent reflectivity of the light L. The diffuser panel 6 has a function of diffusing the light L from the light emitting elements 1, the white resist 2a and the reflection sheet 4.

In the lighting device 5, the light L reflected by the diffuser panel 6 is reflected in both a first reflection region α where the white resist 2a on the board 2 is exposed and a second reflection region β on the reflection sheet 4, as shown in FIG. 26. The optical reflectance in the first reflection region α is normally between about 70 to 80% because the white resist 2a cannot be made any thicker. On the other hand, the optical reflectance in the second reflection region β is normally about 95% or higher because the reflection sheet 4 can be made thicker. Therefore, if the dimension of the first reflection region α is smaller, that is, if the distance D between the rim 3a (an inner peripheral surface) of each aperture 3 in the reflection sheet 4 and a side surface 1b (an outer peripheral surface) of each light emitting element 1 that is positioned within the aperture 3 is smaller, the second reflection region β having an optical reflectance of 95% or higher has a greater area. Such an arrangement provides advantageous optical characteristics in respect of the efficiency in the use of the light L. The distance D is set in advance as tolerance, in consideration of variations such as a variation in size of the light emitting elements 1, a variation in forming the apertures 3 in the reflection sheet 4, a variation in mounting the light emitting elements 1 on the board 2, and a variation in attaching the reflection sheet 4 to the board 2.

In general, the reflection sheet used in a lighting device is subjected to extending process during manufacture such that it is extended in a predetermined specific extending direction.

Depending on the environment under which the mounted lighting device 5 is applied or used, the lighting device 5 is required to operate at a wide range of temperature, especially under an environment at a low or high temperature, compared to the case of the televisions and the digital signage devices. In particular, when the lighting device 5 is used for in-vehicle application, it is necessary to suppose, for example, a durable temperature range of −40 to 95° C.

For example, in the initial state of the lighting device 5 as shown in FIG. 27, the reflection sheet 4 allows unobstructed emission of the light L from the light emitting elements 1. Thus, as shown in FIG. 28, the lighting device 5 can provide uniform lighting, for example, at a luminance uniformity of 90%. which is substantially without luminance unevenness. In this context, the luminance uniformity is a ratio of the minimum luminance to the maximum luminance at a plurality of predetermined locations.

On the other hand, if the lighting device 5 is left under a specific high-temperature environment (for example, under an environment at about 95° C.), the reflection sheet 4 that has been extended in an extending direction E thermally shrinks in the extending direction E, and thus heat-shrunk reflection sheet 4 may cover a light emitting surface 1a, which is an opposite side of the board 2, of the light emitting element 1 as shown in FIG. 29. in this case, the reflection sheet 4 obstructs outgoing light La from the light emitting surface 1a of the light emitting element 1, and darkens the obstructed part, which causes luminance unevenness. In the result, the lighting device 5 has a luminance uniformity, for example, of 68%, and fails to provide uniform illumination as shown in FIG. 30. Thus, the display quality of the display device is eventually degraded.

Also, when a light emitting element that emits the light L not only from the light emitting surface 1a but also from the side surface 1b around the light emitting surface 1a is used as the light emitting element 1 having wider directional characteristics in light emission, such a light emitting element can disperse the light L better and can provide illumination with enhanced uniformity, thereby improving the display quality of the display device in the initial state as shown in FIGS. 27 and 28. However, as shown in FIGS. 29 and 30, after the lighting device is left under a high-temperature environment, the heat-shrunk reflection sheet 4 covers the light emitting surface 1a of the light emitting element 1 and obstructs the light L not only from the light emitting surface 1a of the light emitting element 1 but also from the side surface 1b of the light emitting element 1. Even if not covering, if the heat-shrunk reflection sheet 4 comes into contact with or in proximity to the side surface 1b of the light emitting element 1, the reflection sheet 4 obstructs the light L from the side surface 1b of the light emitting element 1, which darkens the obstructed part. Thus, luminance unevenness is generated.

In this respect, JP 2013-118117 A suggests a lighting device in which cuts are provided around the apertures in the reflection sheet.

However, the lighting device disclosed in JP 2013-118117 A intends to avoid bending of a reflection sheet due to thermal expansion by providing the cuts. According to this structure, if the reflection sheet extended in the extending direction thermally shrinks in the extending direction, heat shrinkage occurs all over the reflection sheet irrespective of the cuts around the apertures in the reflection sheet. Eventually, the heat-shrunk reflection sheet covers the light emitting surface of the light emitting element, or comes into contact with or in proximity to the side surface of the light emitting element, which still causes luminance unevenness.

In view of the above-mentioned problem, an object of the present invention is to provide a lighting device that can effectively prevent luminance unevenness and can thereby provide uniform illumination even when a reflection sheet thermally shrinks under a specific high-temperature environment, and also to provide a display device including the lighting device.

### SUMMARY OF THE INVENTION

In order to solve the above-mentioned problem, a lighting device according to an embodiment of the present invention includes: a board on which a plurality of light emitting elements is arranged in a matrix; and a reflection sheet provided on the board and having a plurality of apertures. The plurality of apertures is each superimposed on a corresponding one of the plurality of light emitting elements. In this lighting device, the reflection sheet is extended in a predetermined specific extending direction. A protrusion part is provided on the board so as to protrude through the reflection sheet. The protrusion part is integrally formed with the board. Also, a display device according to an embodiment of the present invention includes the lighting device according to the above-mentioned embodiment of the present invention.

The present invention can effectively prevent generation of luminance unevenness and can thereby provide uniform illumination even when the reflection sheet thermally shrinks under the specific high-temperature environment.

### BRIEF DESCRIPTION OF THE DRAWINGS

FIG. 1 is a schematic cross-sectional view illustrating a part of a liquid crystal display that is provided with a backlighting device according to the first embodiment.

FIG. 2 is a schematic plan view illustrating the backlighting device shown in FIG. 1, from which an optical element group and a diffuser panel are removed.

FIG. 3 is an enlarged schematic plan view illustrating a part of the backlighting device shown in FIG. 2.

FIG. 4 is a schematic perspective view illustrating a protrusion part provided on an LED board of the backlighting device shown in FIG. 1, viewed from the side of the LED board.

FIG. 5 is a schematic perspective view illustrating the protrusion part provided on the LED board and an insertion part provided in a reflection sheet of the backlighting device shown in FIG. 1, viewed from the side facing the LED board.

FIG. 6 is a schematic plan view illustrating the protrusion part and the insertion part of the backlighting device shown in FIG. 1, with LEDs and apertures.

FIG. 7 is a schematic plan view illustrating one end of the LED board in an extending direction of the backlighting device shown in FIG. 1.

FIG. 8 is a schematic perspective view illustrating a configuration in which the protrusion part is extended in an orthogonal direction in one example of the backlighting device according to the second embodiment, viewed from the side of the LED board.

FIG. 9 is a schematic side view illustrating the protrusion part that is extended in the orthogonal direction of the backlighting device shown in FIG. 8, viewed from the extending direction.

FIG. 10 is a schematic cross-sectional view illustrating a configuration in which the protrusion part supports a diffuser panel in one example of the backlighting device according to the third embodiment.

FIG. 11 is a schematic cross-sectional view illustrating a configuration in which the protrusion part supports the diffuser panel in another example of the backlighting device according to the third embodiment.

FIG. 12 is a schematic cross-sectional view illustrating a configuration in which the protrusion part is inserted into a recess part of the diffuser panel in one example of the backlighting device according to the fourth embodiment.

FIG. 13 is a schematic cross-sectional view illustrating a configuration in which a specific pattern is printed in ink on a surface of the diffuser panel that faces the LED board in one example of the backlighting device according to the fifth embodiment.

FIG. 14 is a schematic perspective view illustrating a configuration in which a tip part of the protrusion part is formed so as to have a shape of an acute angle in one example of the backlighting device according to the sixth embodiment.

FIG. 15 is a schematic perspective view illustrating a configuration in which the reflection sheet is provided on the LED board of the backlighting device shown in FIG. 14.

FIG. 16 is a schematic perspective view illustrating a configuration, as an example, in which the protrusion part supports the diffuser panel of the backlighting device shown in FIG. 14.

FIG. 17 is a schematic perspective view illustrating one example in which a plurality of protrusion parts is randomly provided on the LED board of the backlighting device shown in FIG. 14.

FIG. 18 is a schematic perspective view illustrating one example in which a reflection member is provided on the protrusion part of the backlighting device shown in FIG. 14.

FIG. 19 is a schematic plan view illustrating a configuration in which the LEDs are electrically connected to electric connection parts of the LED board.

FIG. 20 is a schematic bottom view indicating a region for providing the protrusion part on the LED board.

FIG. 21 is a circuit diagram illustrating one example of an electric circuit corresponding to the wiring pattern shown in FIG. 20.

FIG. 22 is a schematic plan view illustrating one example of the LED board including the protrusion part.

FIG. 23 is a schematic cross-sectional view illustrating a conventional direct-lit type lighting device.

FIG. 24 is a schematic cross-sectional view illustrating a configuration in which light is diffused by a diffuser panel and a reflection sheet of the lighting device shown in FIG. 23.

FIG. 25 is a schematic perspective view illustrating one example in which the reflection sheet is provided on a board on which a plurality of light emitting elements is arranged in a matrix.

FIG. 26 is a schematic cross-sectional view illustrating a distance between each rim of a corresponding aperture in the reflection sheet and a light emitting element.

FIG. 27 is a schematic cross-sectional view illustrating the positional relationship between the aperture and the reflection sheet in an initial state.

FIG. 28 is a distribution map indicating a luminance distribution of the lighting device in the initial state.

FIG. 29 is a schematic cross-sectional view illustrating the positional relationship between the aperture and the reflection sheet after the lighting device is left under a high-temperature environment.

FIG. 30 is a distribution map indicating a luminance distribution of the lighting device after the lighting device is left, under a high-temperature environment.

### DESCRIPTION OF THE PREFERRED EMBODIMENTS

Hereinafter, the embodiments of the present invention are described with reference to the drawings. In the following description, the same components are indicated by the same reference signs, and the appellations and functions are also the same. Therefore, detailed description thereof is omitted.

### First Embodiment

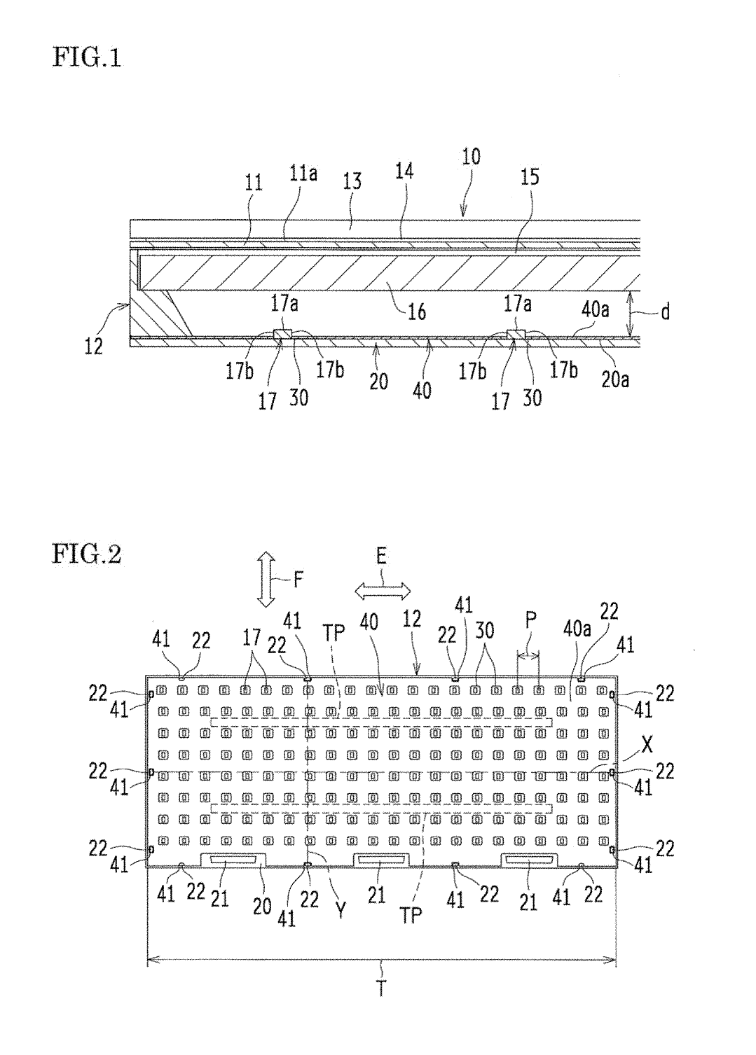

FIG. 1 is a schematic cross-sectional view illustrating a part of a liquid crystal display 10 that is provided with a backlighting device 12 according to the first embodiment. FIG. 2 is a schematic plan view illustrating the backlighting device 12 shown in FIG. 1, from which an optical element group 15 and a diffuser panel 16 are removed.

As shown in FIG. 1, the liquid crystal display (an example of the display device) 10 has a laterally long rectangular shape as a whole and is horizontally placed in use. In this example, the liquid crystal display 10 has a 12.3-inch display screen used for in-vehicle application. The liquid crystal display 10 includes: a liquid crystal panel 11; and a backlighting device (an example of the lighting device) 12 that illuminates the liquid crystal panel 11 from behind. The shape of the liquid crystal display 10 is not particularly limited. The liquid crystal display 10 may also have a square shape.

Although the detailed configuration of the liquid crystal panel 11 is not shown in the drawings, the liquid crystal panel 11 has the configuration in which: a pair of glass substrates is bonded to each other at a certain gap; and liquid crystal is encapsulated between the glass substrates.

The backlighting device 12, which is a direct-lit type device, is disposed on the opposite side of a display surface 11a of the liquid crystal panel 11. The backlighting device 12 includes: the optical element group 15; the diffuser panel 16; a reflection sheet 40; and an LED hoard 20 (an example of the board). The optical element group 15 is made by laminating a plurality of optical sheets so as to have the thickness thinner than the diffuser panel 16, and is arranged between the liquid crystal panel 11 and the diffuser panel 16. The optical element group 15 has a function of converting light that passes through the diffuser panel 16 into planar light. The optical element group 15 is principally constituted of, although not shown in the drawings, a brightness enhancement film and a prism sheet. The diffuser panel 16 is constituted of a plate-like synthetic resin member and light scattering particles dispersed therein, and has a light diffusing function.

The LED board 20 is coated with a white resist 20a (specifically, white ink). On the LED hoard 20 coated with the white resist 20a, a plurality of light emitting diodes 17 (an example of light emitting elements, hereinafter referred to as “LEDs 17”) that emits white light is arranged in a matrix at a predetermined specific identical pitch P (about 13 mm in this example) (see FIG. 2). The LEDs 17 emit light from respective light emitting surfaces 17a that are the opposite surfaces of the LED board 20. In this example, so-called top-view light emitting LEDs are used as the LEDs 17. Each LED 17 is provided in a transparent resin package so as to emit light also from a side surface 17b and to ensure wide directional characteristics in light emission. With this configuration, the LEDs 17 can emit light not only from the light emitting surfaces 17a but also from the side surfaces 17b around the light emitting surfaces 17a. The LEDs 17 are chip LEDs mounted on the LED board 20 such as a rigid board (for example, a board made of a metallic material such as aluminum to have a rigidity) or a flexible printed board (for example, a hoard made of a resin material such as polyimide to have a flexibility). The LED board 20 is electrically connected to a power source unit (not shown) controlled by a power source control unit (not shown), via connectors 21. A specific voltage is applied from the power source unit and lights up the LEDs 17. The power source control unit performs local dimming control to the power source unit. In this way, the backlighting device 12 illuminates the liquid crystal panel 11 at high luminance and high contrast. All of the LEDs 17 are made in the same shape (the same specification). Typically, the shape of the LEDs 17 in plan view (i.e. the shape of the light emitting surfaces 17a) may be rectangular, square, elliptical, or circular.

The diffuser panel 16 is provided above the LED board 20 at a predetermined specific interval d (about 4 mm in this example) so as to face a surface of the LED board 20 on which the LEDs 17 are mounted. Materials for the diffuser panel 16 include heat-resistant resin materials such as polycarbonate resins and acrylic resins. In this example, the diffuser panel 16 is made of a polycarbonate resin. The interval d between the diffuser panel 16 and the LED board 20 can be determined, for example, depending on a pitch P between the LEDs 17.

The liquid crystal display 10 further includes a transparent protective member 13 provided on the liquid crystal panel 11. The transparent protective member 13 is adhered to the liquid crystal panel 11 via a transparent adhesive member 14 such as a functional film (i.e. an optical clear adhesive (OCA) film). The transparent protective member 13 may be configured by cover glass or a touch panel, and has a function of protecting the display surface 11a of the liquid crystal panel 11.

(Reflection Sheet)

Here, the reflection sheet 40 is described in detail. The reflection sheet 40 includes a white reflection surface 40a having an excellent light reflectivity. The reflection sheet 40 is provided on the LED board 20 (specifically, on the surface of the LED board 20 on which the LEDs 17 are mounted). The reflection sheet 40 has a plurality of apertures 30. The plurality of apertures 30 in the reflection sheet 40 is each superimposed on a corresponding one of the LEDs 17, and exposes the corresponding LED 17 therethrough (i.e. allows the corresponding LED 17 to project therethrough). The apertures 30 may be shaped according to the shape of the LEDs 17, that is, in the same or substantially the same shape as the LEDs 17. All of the apertures 30 have an identical shape. The reflection sheet 40 is attached to the LED board 20 by double-sided adhesive sheets TP at multiple positions. Materials for the reflection sheet 40 include, for example: PET (polyethylene terephthalate) resins; PP (polypropylene) resins; PVC (polyvinyl chloride) resins; PC (polycarbonate) resins; and PMMA (acrylic) resins. In this example, the reflection sheet 40 is made of a PET resin. The reflection sheet 40 is subjected to extending process so as to be extended in a predetermined specific extending direction E during manufacture. Here, the extending direction E of the reflection sheet 40 can be confirmed, for example, using an ellipsometer for measuring a change in polarization between the incident light on and the reflected light from the reflection sheet 40. Specifically, considering a phase shift and a difference in optical reflectance between s polarization and p polarization, the change in polarization between the incident light and the reflected light is defined by the phase difference Δ between s polarization and p polarization and the reflection-amplitude ratio Ψ between s polarization and p polarization, and is usually represented as (Ψ, Δ).

Note that in FIG. 2, the reference signs 22 and 41 respectively indicate a protrusion part and an insertion part, which are described later.

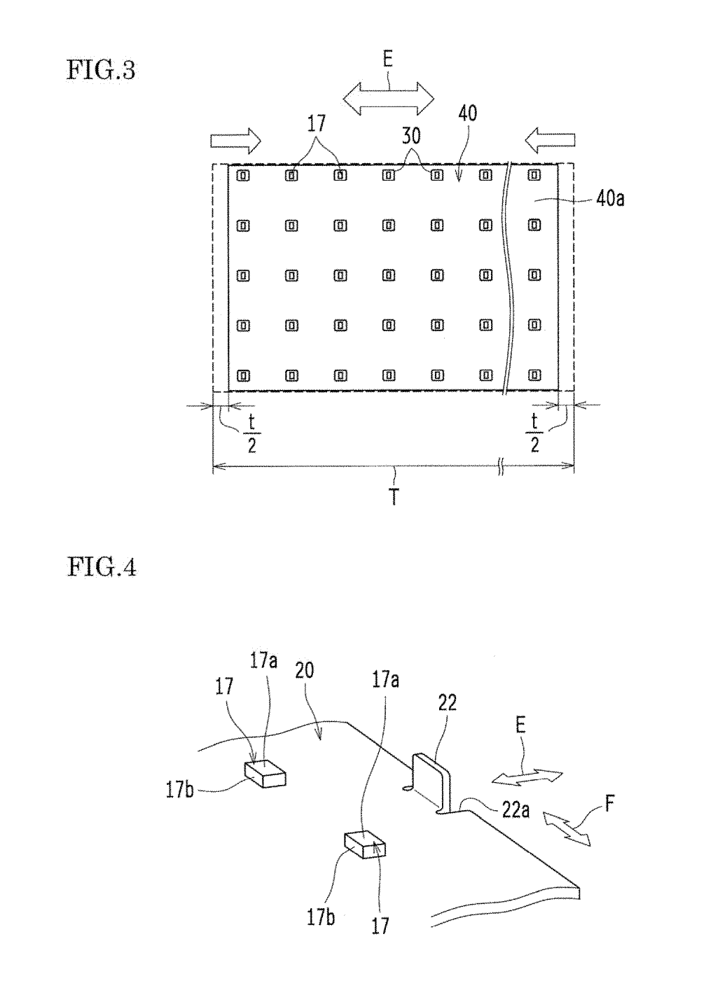

FIG. 3 is an enlarged schematic plan view illustrating a part of the backlighting device 12 shown in FIG. 2. The backlighting device 12 is required to have heat-resistance under a specific high-temperature environment (for example, a temperature over 60° C.). Meanwhile, the extended reflection sheet 40 thermally shrinks in the extending direction E under a specific high-temperature environment that causes heat shrinkage of the reflection sheet 40. For example, under a high-temperature environment at 95° C., the reflection sheet 40 made of a PET resin shrinks at a heat shrinkage rate μ of about 0.4%, in a heat shrinkage amount t of about 1.2 mm relative to the total length T, about 300 mm, of the reflection sheet 40 in the extending direction E. In this context, the heat shrinkage rate μ is a ratio of the heat shrinkage amount t of the reflection sheet 40 in the extending direction E under the specific high-temperature environment relative to the total length T of the reflection sheet 40 in the extending direction E.

On the other hand, if the apertures 30 of the reflection sheet 40 are made larger in consideration of the heat shrinkage of the reflection sheet 40 in the extending direction E, the area of the reflection region on the reflection sheet 40 is reduced, which may result in less efficient use of light. Therefore, it is desired to prevent reduction in the efficiency in the use of light while effectively preventing generation of luminance unevenness despite the heat shrinkage of the reflection sheet 40 in the extending direction E.

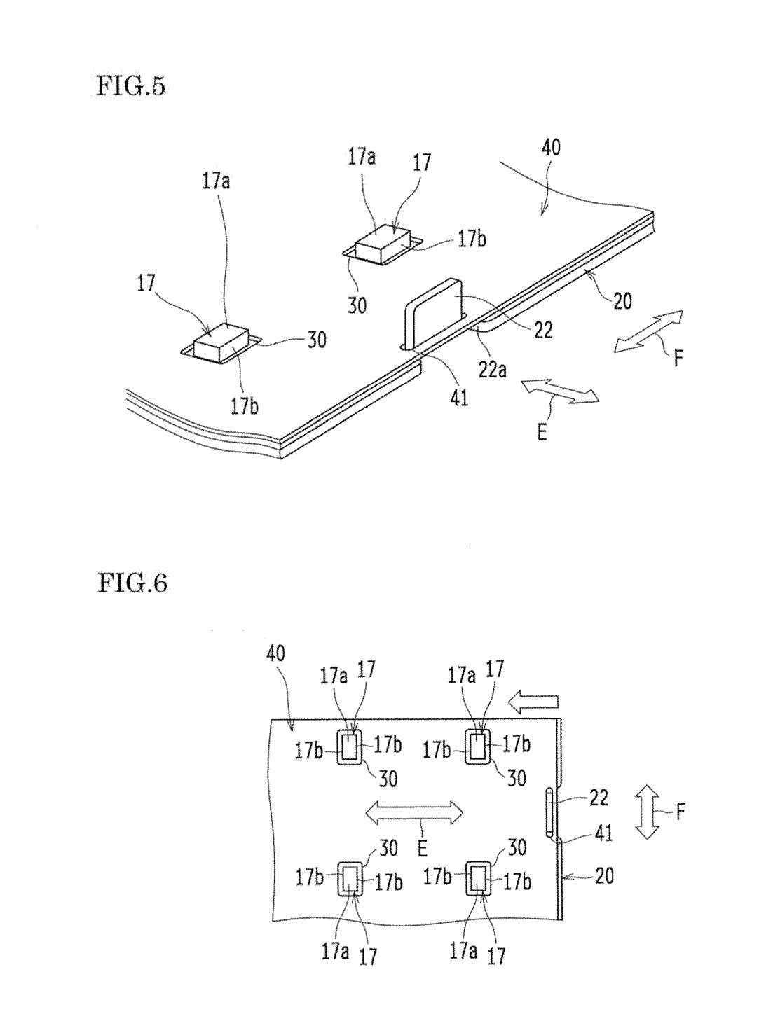

FIG. 4 is a schematic perspective view illustrating the protrusion part 22 provided on the LED board 20 of the backlighting device 12 shown in FIG. 1, viewed from the side of the LED board 20. FIG. 5 is a schematic perspective view illustrating the protrusion part 22 provided on the LED board 20 and an insertion part 41 provided in the reflection sheet 40 of the backlighting device 12 shown in FIG. 1, viewed from the side facing the LED board 20. FIG. 6 is a schematic plan view illustrating the protrusion part 22 and the insertion part 41 of the backlighting device 12 shown in FIG. 1, with LEDs 17 and apertures 30.

As shown in FIGS. 4 to 6, the protrusion part 22 is provided on the LED board 20 so as to protrude through the reflection sheet 40. The protrusion part 22 is integrally formed with the LED board 20.

In this embodiment, even when the reflection sheet 40 thermally shrinks in the extending direction E under the specific high-temperature environment that causes heat shrinkage of the reflection sheet 40, it is possible to reduce (restrict) the heat shrinkage of the reflection sheet 40 since the protrusion part 22 of the LED board 20, which is integrally formed with the LED board 20, comes in contact with the side surface of the reflection sheet 40. In this way, it is possible to prevent the heat-shrunk reflection sheet 40 from covering the light emitting surface 17a of the LED 17. Thus, even when the reflection sheet 40 thermally shrinks under the specific high-temperature environment, the luminance unevenness can be effectively avoided, which leads to uniform illumination. The above configuration is effective particularly in the case where the LED 17 emits light from both the light emitting surface 17a and the side surface 17b.

In this embodiment, the insertion part 41 is disposed in the reflection sheet 40 such that the protrusion part 22 of the LED board 20 is inserted into the insertion part 41, With this configuration, the protrusion part 22 of the LED board 20 comes into contact with the side surface of the reflection sheet 40 within the insertion part 41 of the reflection sheet 40. Thus, it is possible to reliably reduce the heat shrinkage of the reflection sheet 40.

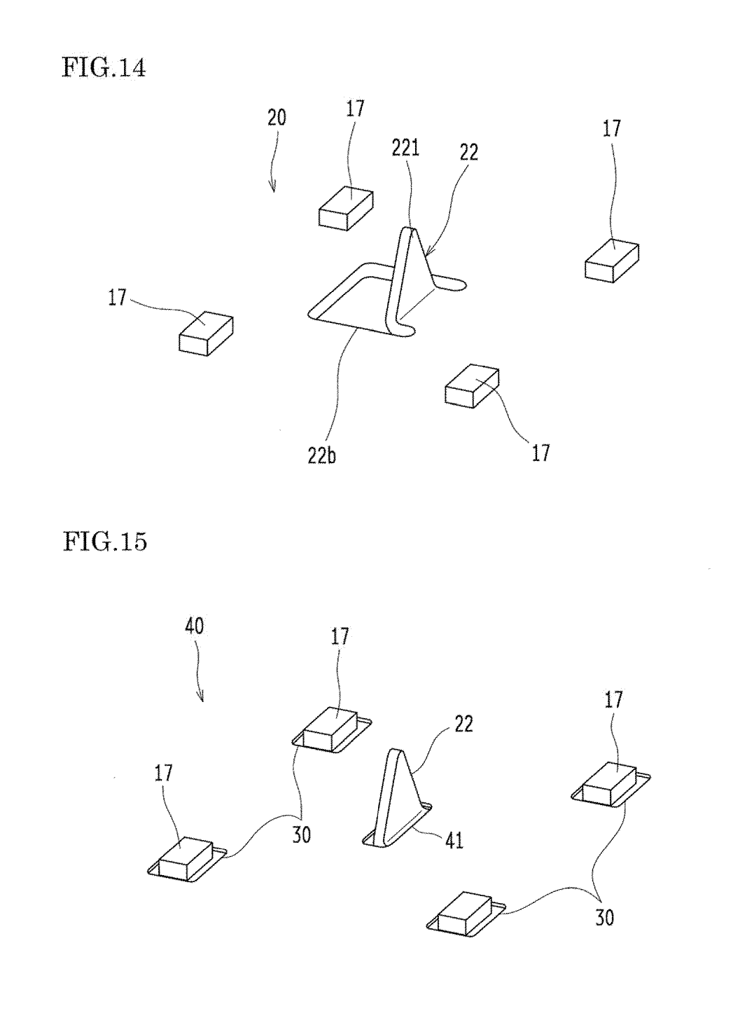

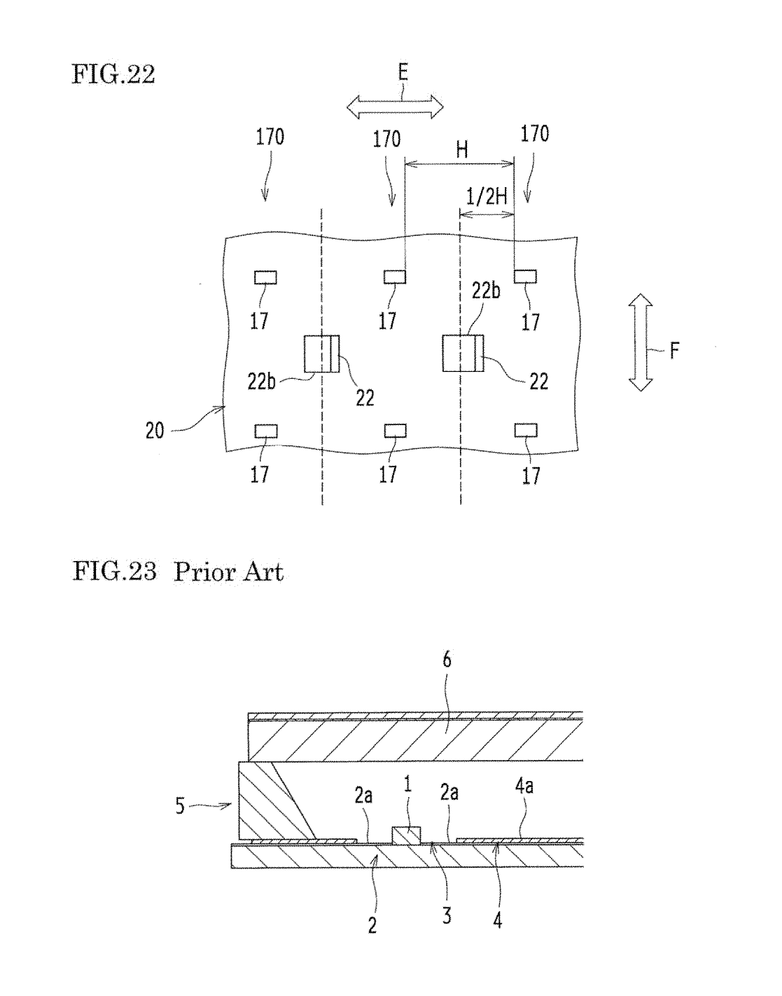

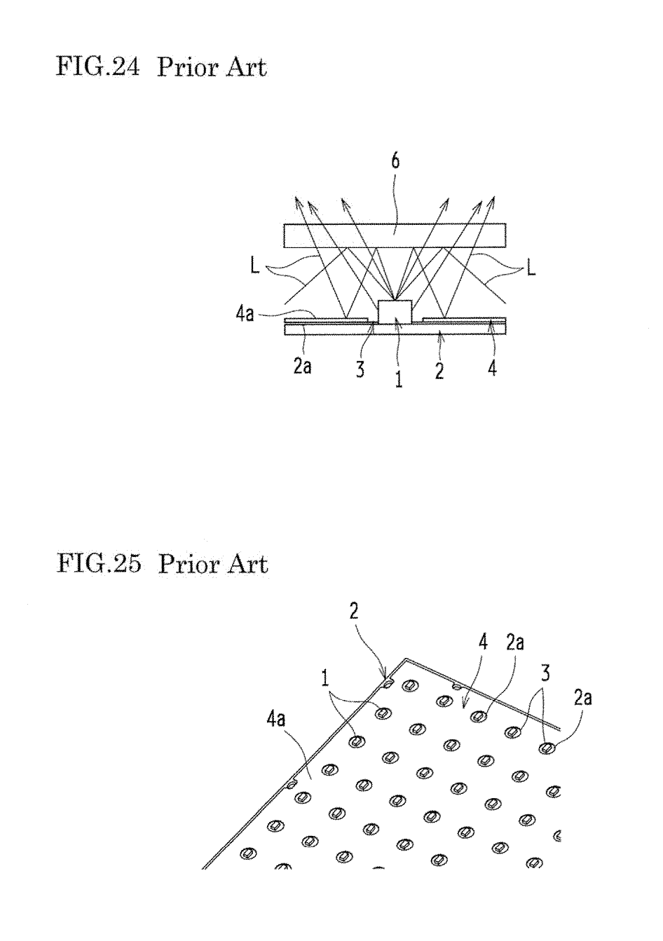

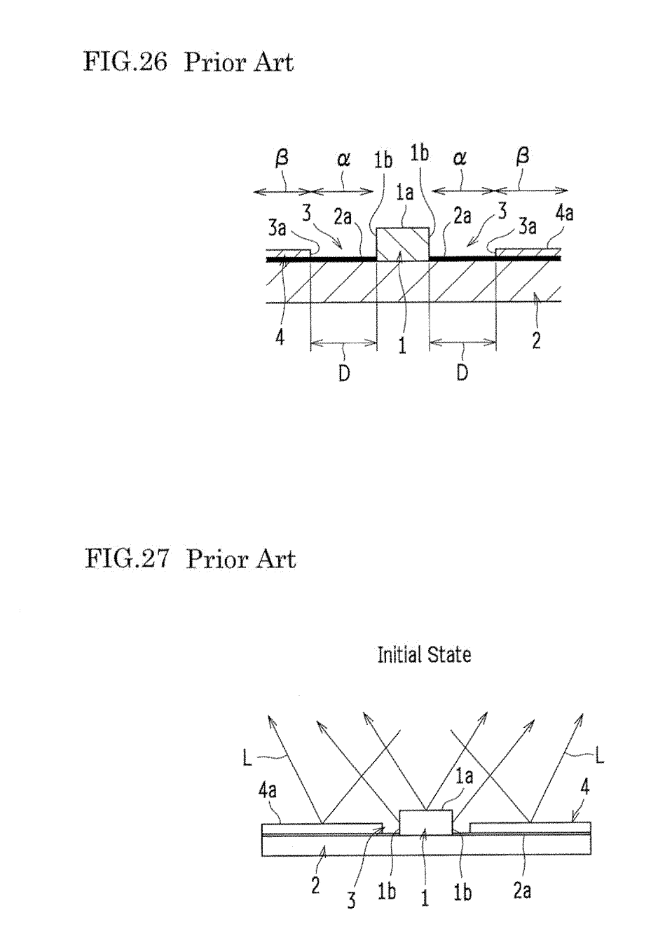

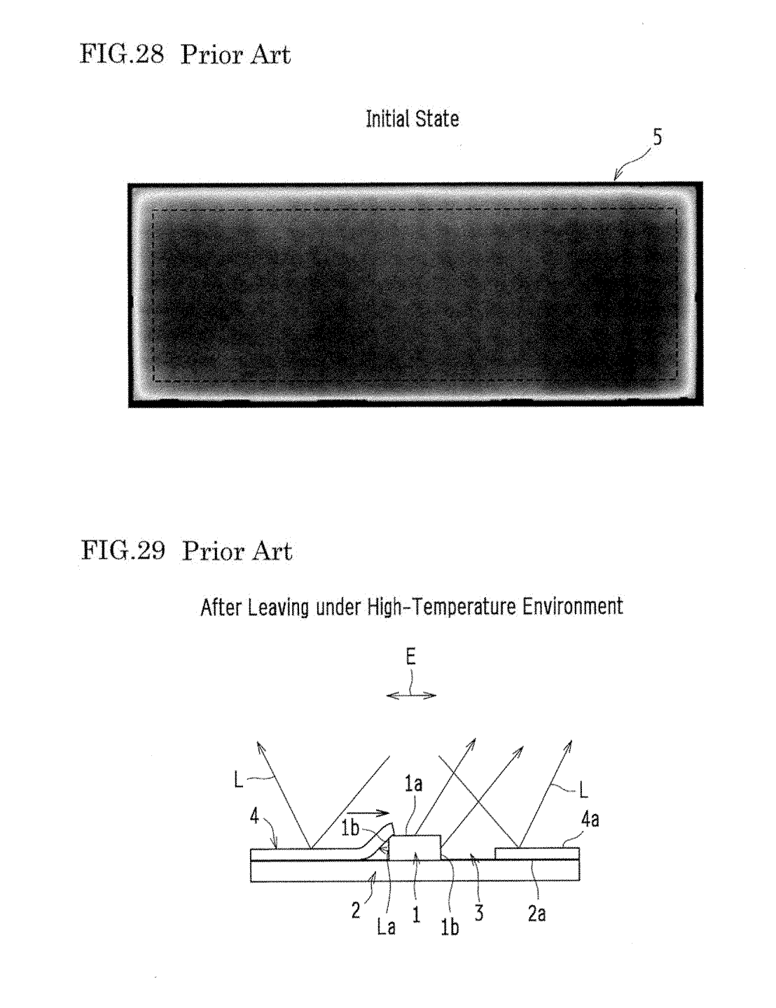

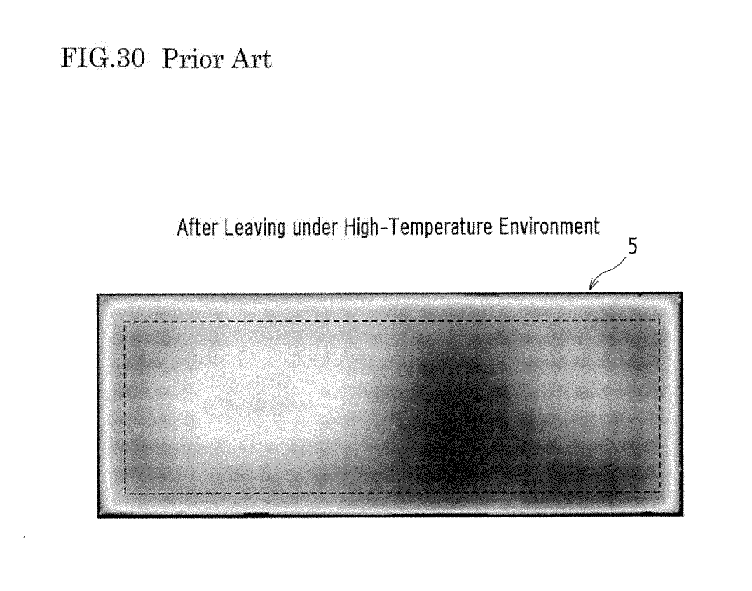

The insertion part 41 may be, for example, a penetrating cut-out that penetrates the reflection sheet 40 (see the reference sign 22a in FIGS. 4 and 5), a through hole (see the reference sign 22b in FIGS. 14 and 22, which is described later), a bottomed cut-out, or a bottomed hole. The protrusion part 22 and the insertion part 41 may be in contact with each other or may be separated from each other in the extending direction E. When the protrusion part 22 and the insertion part 41 are separated from each other in the extending direction E, the interval between the protrusion part 22 and the insertion part 41 in the extending direction E can be set taking into account the heat shrinkage amount of the reflection sheet 40. Also, the protrusion part 22 and the insertion part 41 may be in contact with each other or may be separated from each other in an orthogonal direction F that is orthogonal to the extending direction E. When the protrusion part 22 and the insertion part 41 are separated from each other in the orthogonal direction F, the interval between the protrusion part 22 and the insertion part 41 in the orthogonal direction F can be set as an interval that does not prevent the insertion part 41 and the protrusion part 22 from positioning the reflection sheet 40 in the orthogonal direction F.

In this embodiment, the protrusion part 22 is a bent part made by bending a part of the LED board 20. Thus, the protrusion part 22 as the cut and bent part of the LED board 20 can be easily formed by a simple process constituted of: cut-out processing for cutting out a part thereof; and bend processing for bending the cut-out part.

Materials used for the LED board 20 include metals such as aluminum and copper, which can be subjected to the bend processing.

As shown in FIGS. 4 to 6, it is preferable that the protrusion part 22 is bent in the direction perpendicular to the extending direction E of the reflection sheet 40. In this way, when the reflection sheet 40 thermally shrinks in the extending direction E, the protrusion part 22 fixes the position of the reflection sheet 40. Thus, it is possible to reliably reduce the heat shrinkage of the reflection sheet 40.

The protrusion part 22 may be bent such that a crease is formed along the orthogonal direction F of the reflection sheet 40. In this case, the size of the insertion part 41 in the extending direction E can be made smaller than the size thereof in the orthogonal direction F. Also, the protrusion part 22 may be bent such that a crease is formed along the extending direction E. In this case, the strength of the insertion part 41 in the extending direction E can be improved.

As shown in FIG. 2, in this embodiment, a plurality of protrusion parts 22 is arranged on the LED board 20 in the extending direction E in such a manner that the protrusion parts 22 are spaced apart from one another. In this way, it is possible to reliably reduce the heat shrinkage of the reflection sheet 40 in the extending direction E thanks to the plurality of protrusion parts 22 arranged on the LED board 20 in the extending direction E.

As shown in FIG. 2, in this embodiment, the protrusion parts 22 are positioned on a first imaginary straight line X on the LED board 20 along the extending direction E. In this way, it is possible to reliably reduce the heat shrinkage of the reflection sheet 40 on the first imaginary straight line X thanks to the protrusion parts 22 arranged on the first imaginary straight line X along the extending direction E.

As shown in FIG. 2, in this embodiment, the protrusion parts 22 are positioned on a second imaginary straight line Y on the LED board 20 along the orthogonal direction F. In this way, it is possible to reliably reduce the heat shrinkage of the reflection sheet 40 on the second imaginary straight line Y thanks to the protrusion parts 22 arranged on the second imaginary straight line Y along the orthogonal direction F.

As shown in FIG. 2, in this embodiment, the protrusion parts 22 are arranged on both ends of the LED board 20 in the extending direction E. In this way, it is possible to reliably reduce the heat shrinkage of the reflection sheet 40 on both ends of the LED board 20 in the extending direction E thanks to the protrusion parts 22 arranged on both ends of the LED board 20 in the extending direction E.

As shown in FIG. 2, in this embodiment, the protrusion parts 22 are arranged on both ends of the LED board 20 in the orthogonal. direction F. In this way, it is possible to reliably reduce the heat shrinkage of the reflection sheet 40 on both ends of the LED board 20 in the orthogonal direction F thanks to the protrusion parts 22 arranged on both ends of the LED board 20 in the orthogonal direction F.

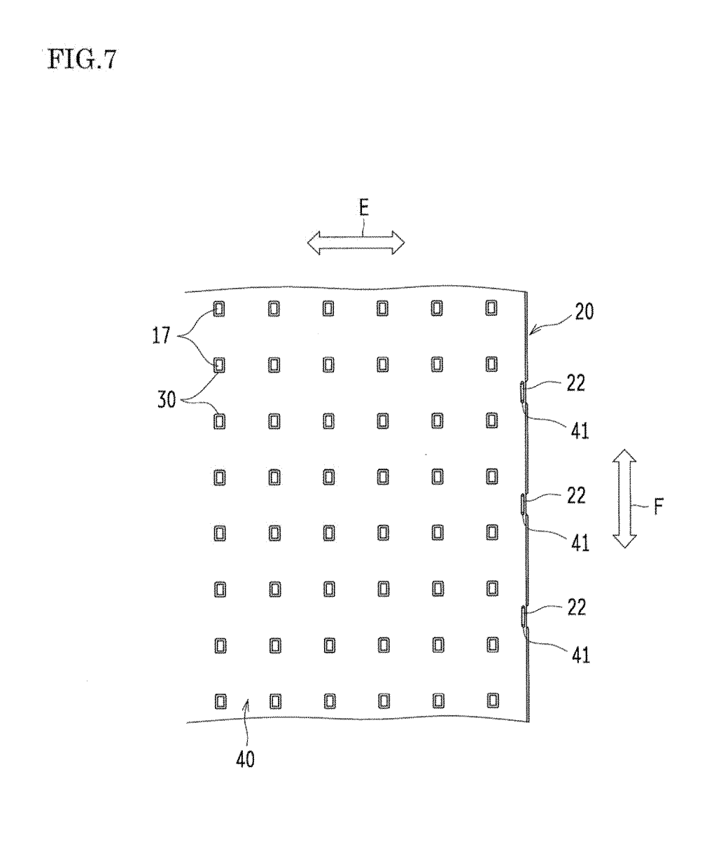

FIG. 7 is a schematic plan view illustrating one end of the LED board 20 in the extending direction E of the backlighting device 12 shown in FIG. 1. As shown in FIG. 7, a plurality of protrusion parts 22 is arranged on the LED board 20 in the orthogonal direction F in such a manner that the protrusion parts 22 are spaced apart from one another. In this way, it is possible to reliably reduce the heat shrinkage of the reflection sheet 40 in the orthogonal direction F thanks to the plurality of protrusion parts 22 arranged on the LED board 20 in the orthogonal direction F. In this example, the protrusion parts 22 are arranged on both ends of the LED board 20 in the extending direction E.

### Second Embodiment

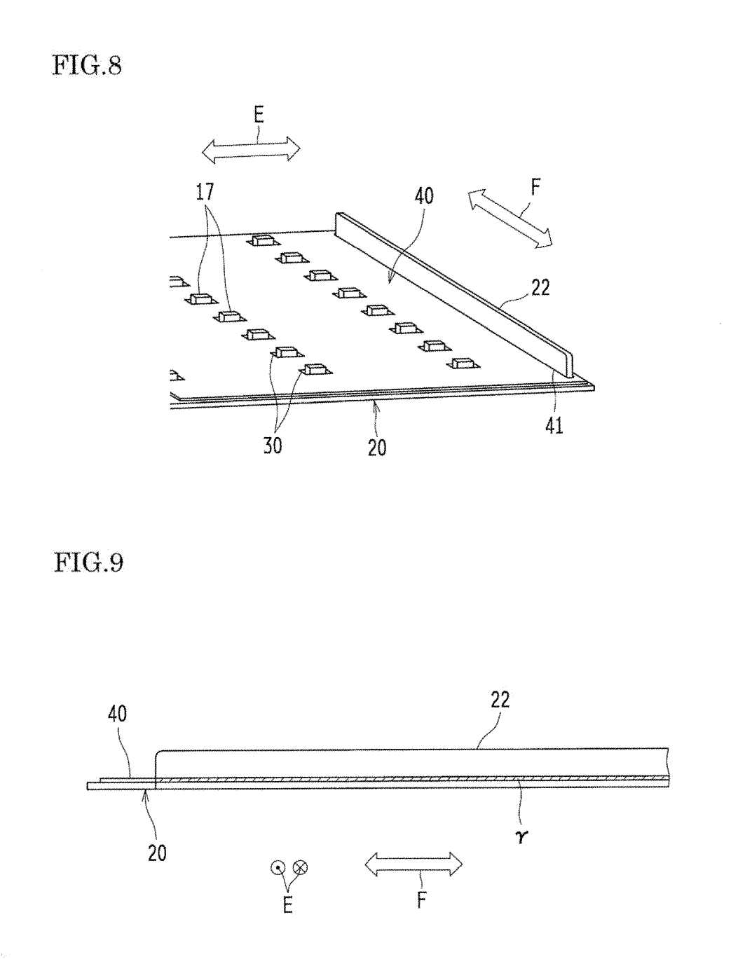

FIG. 8 is a schematic perspective view illustrating a configuration in which the protrusion part 22 is extended in the orthogonal direction F in one example of the backlighting device 12 according to the second embodiment, viewed from the side of the LED board 20. FIG. 9 is a schematic side view illustrating the protrusion part 22 that is extended in the orthogonal direction F of the backlighting device 12 shown in FIG. 8, viewed from the extending direction E. In the backlighting device 12 according to the second embodiment, the direction of the LEDs 17 and the apertures 30 differs from the direction thereof in the backlighting device 12 according to the first embodiment. However, the direction may be the same as that in the first embodiment.

As shown in FIGS. 8 and 9, the protrusion part 22 is extended on the LED board 20 in the orthogonal direction F. With this configuration, it is possible to increase the contact area (see the hatched part γ in FIG. 9) of the protrusion part 22 with the reflection sheet 40 in the orthogonal direction F when the reflection sheet 40 thermally shrinks. Thus, the protrusion part 22 extended on the LED board 20 in the orthogonal direction F stably holds the reflection sheet 40 in the orthogonal direction F, which can reliably reduce the heat shrinkage of the reflection sheet 40 in the extending direction E. Therefore, it is possible to improve the effect of reducing the heat shrinkage of the reflection sheet 40. In this example, the protrusion part 22 is extended on the entire or substantially entire surface of the LED board 20 in the orthogonal direction F.

### Third Embodiment

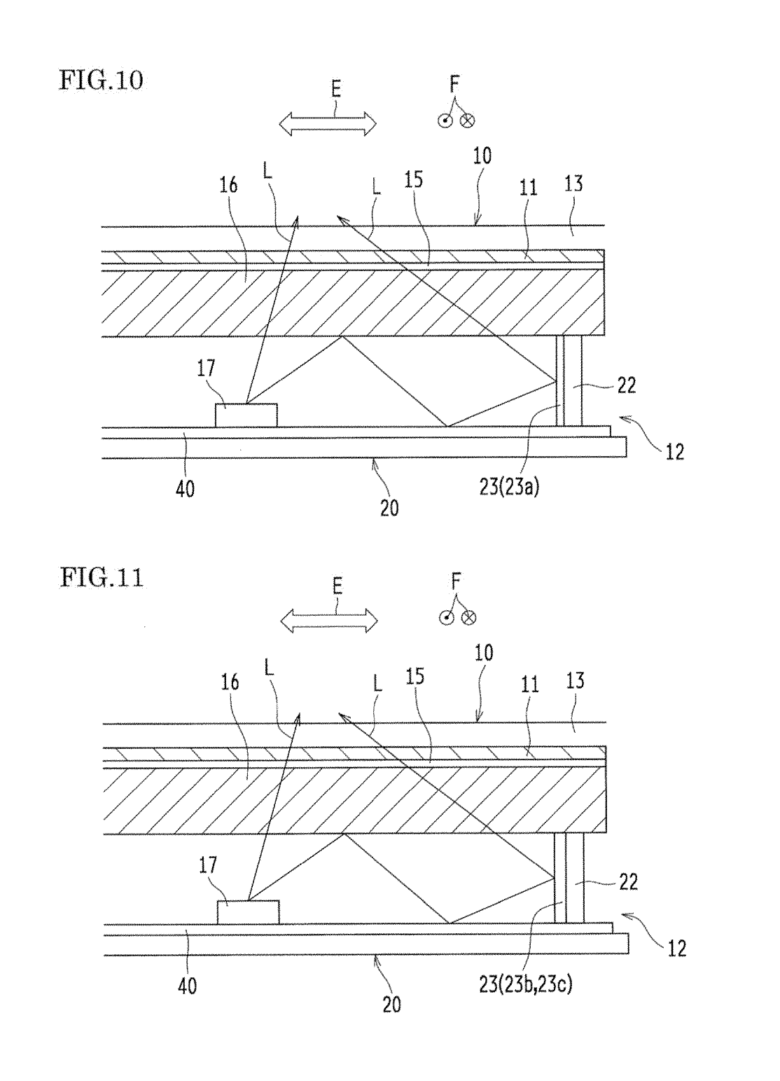

FIGS. 10 and 11 are schematic cross-sectional views respectively illustrating configurations in which the protrusion part 22 supports the diffuser panel 16 in one example and another example of the backlighting device 12 according to the third embodiment.

As shown in FIGS. 10 and 11, the backlighting device 12 according to the third embodiment has a configuration in which the protrusion part 22 supports the diffuser panel 16. In this way, the configuration in which the protrusion part 22 supports the diffuser panel 16 can also be a configuration in which the protrusion part 22 supports the diffuser panel 16 and the optical element group 15, which contributes to further simplification of the configuration of the backlighting device 12. In this example, the height of the bent part cut and raised at the end of the LED board 20 is appropriately set.

Depending on the optical reflectance of the protrusion part 22, the efficiency in the use of the light L may be degraded. Therefore, it is desired to improve the efficiency in the use of the light L in the protrusion part 22.

In this respect, the protrusion part 22 includes a reflection member 23. In this way, it is possible to improve the optical reflectance thanks to the reflection member 23 provided on the protrusion part 22, which contributes to improvement of the efficiency in the use of the light L. Although it is preferable that the reflection member 23 is provided over the entire protrusion part 22, however, on the protrusion part 22 at the end of the reflection sheet 40, for example, the reflection member 23 may be provided on only the inner side thereof. The reflection member 23 may be, for example, a white resist, a reflection sheet, or a reflection tape. In the example shown in FIG. 10, a white resist 23a is applied onto the surface of the reflection member 23. Thus, the reflection efficiency of the light L emitted from the LEDs 17 can be improved, which leads to more effective use of the light L. Generally, the white resist 23a has the reflectance of about 70%. Accordingly, it can be expected that the efficiency in the use of the light L is further improved by applying, as shown in FIG. 11, a reflection sheet 23b or a reflection tape 23c that generally have the reflectance of 95% or more.

### Fourth Embodiment

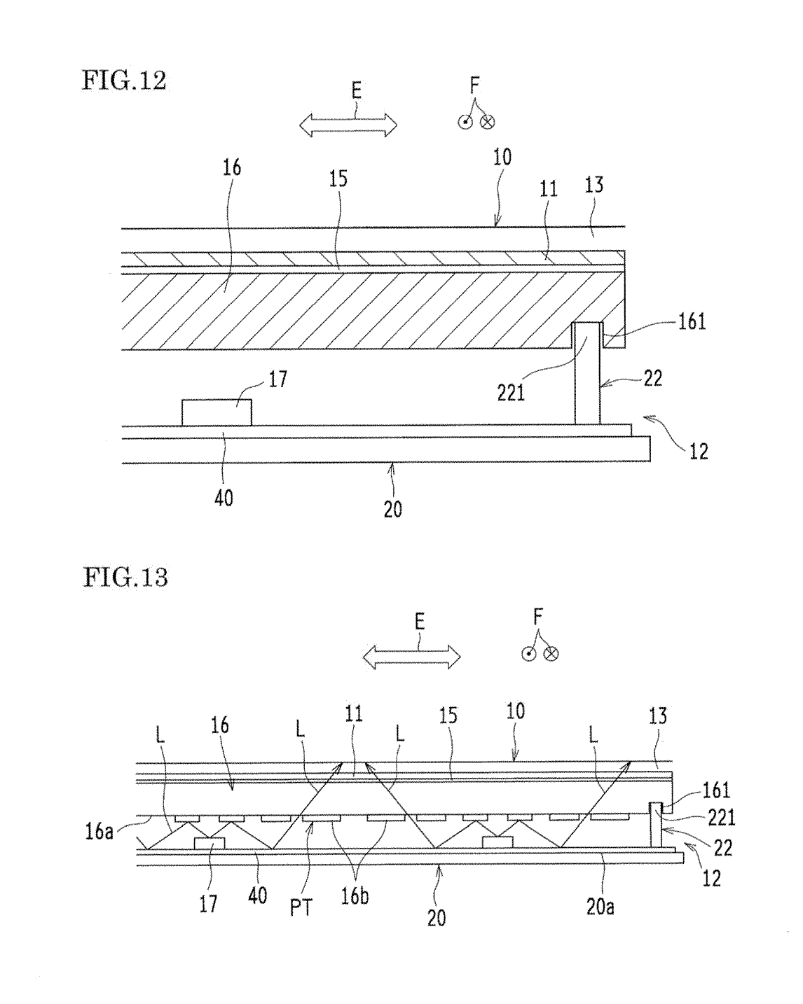

FIG. 12 is a schematic cross-sectional view illustrating a configuration in which the protrusion part 22 is inserted into a recess part 161 of the diffuser panel 16 in one example of the backlighting device 12 according to the fourth embodiment.

As shown in FIG. 12, in the backlighting device 12 according to the forth embodiment, the diffuser panel 16 includes a recess part 161 into which a tip part 221 of the protrusion part 22 is inserted. With this configuration, the protrusion part 22 reliably supports the diffuser panel 16 inside the recess part 161. The respective widths of the recess part 161 of the diffuser panel 16 in the extending direction E and in the orthogonal direction F may be set such that the protrusion part 22 is smoothly inserted thereinto.

### Fifth Embodiment

Recently, there is a demand for a thinner backlighting device 12 for the liquid crystal display 10 (for example, a liquid crystal display 10 for in-vehicle use). The thickness of the backlighting device 12 can be reduced, for example, by forming a predetermined specific pattern on the diffuser panel 16.

FIG. 13 is a schematic cross-sectional view illustrating a configuration in which a specific pattern PT is printed in ink on an opposite surface 16a of the diffuser panel 16 that faces the LED board 20 in one example of the backlighting device 12 according to the fifth embodiment.

In the backlighting device 12 according to the fifth embodiment, the predetermined specific pattern PT is provided on the diffuser panel 16 as shown in FIG. 13.

In the configuration shown in FIG. 13, the specific pattern PT (for example, a dot pattern) is formed on the opposite surface 16a of the diffuser panel 16 that faces the LED board 20, by silkscreen printing using a white resist 16b (specifically, white ink). The white resist 16b may be made of the same material as the white resist 20a formed on the LED board 20. Here, as shown in FIG. 13, the specific pattern PT is designed to change the optical reflectance according to the luminance distribution of the LEDs 17 (i.e. depending on the distance from the light source) such that the light L emitted from the LEDs 17 can be uniform. The pattern PT is regularly arranged directly above the respective LEDs 17. Each part of the pattern PT blocks the light L directly above the corresponding LED 17, repeats reflection and diffusion of the light L, and thus realizes uniform illumination of the light L. In this way, the backlighting device 12 can be made further thinner. However, the thinning of the backlighting device 12 leads to further increase in the temperature, which results in a further higher temperature inside the backlighting device 12. In this situation, the configuration in which the protrusion part 22 is integrally formed with the LED board 20 is more effective.

In the case in which the predetermined specific pattern is provided on the diffuser panel 16, when the diffuser panel 16 thermally expands or shrinks, the relative positional relationship between the pattern PT and the LEDs 17 may be displaced, which results in luminance unevenness. Thus, it is desired to reduce the displacement of the relative positional relationship between the pattern PT and the corresponding LEDs 17.

In this respect, in this embodiment, the relative positional relationship between the pattern PT and the LEDs 17 is maintained. With this configuration, it is possible to reliably maintain the relative positional relationship between the pattern PT and the LEDs 17. Also, since the displacement of the relative positional relationship between the pattern PT and the LEDs 17 can be reduced, it is possible to prevent generation of luminance unevenness in the displayed image. In this example, since the protrusion part 22 is inserted into the recess part 161 of the diffuser panel 16, it is possible to reduce negative influence due to change in the size of the device caused by the thermal expansion or shrinkage of the diffuser panel 16. Thus, it is possible to maintain the relative positional relationship between the pattern PT of the diffuser panel 16 and the LEDs 17 of the LED board 20 (i.e. the relative positional relationship in the direction of the surface of the diffuser panel 16 facing the LEDs 17, for example, in the extending direction E). In the result, it is possible to prevent generation of luminance unevenness caused by the displacement of the positions of the LEDs 17 and the position of the pattern PT (dot printing pattern).

### Sixth Embodiment

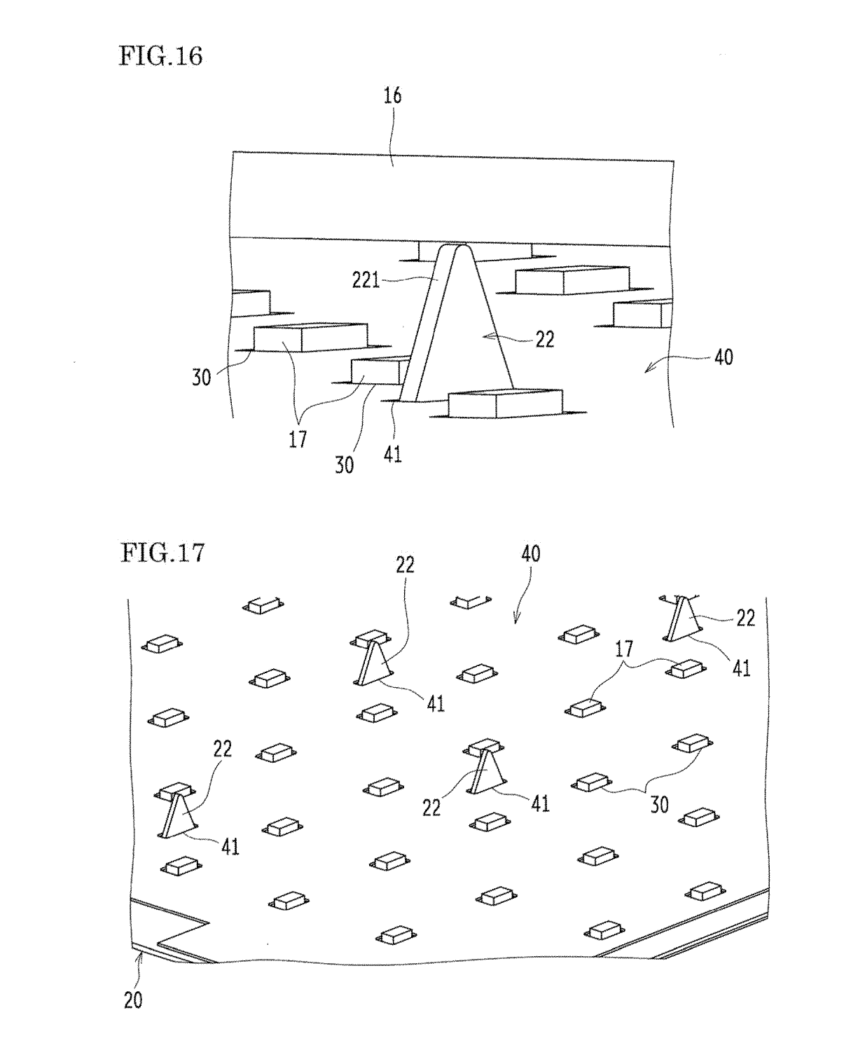

FIG. 14 is a schematic perspective view illustrating a configuration in which the tip part 221 of the protrusion part 22 is formed so as to have a shape of an acute angle in one example of the backlighting device 12 according to the sixth embodiment. FIG. 15 is a schematic perspective view illustrating a configuration in which the reflection sheet 40 is provided on the LED board 20 of the backlighting device 12 shown in FIG. 14. FIG. 16 is a schematic perspective view illustrating a configuration, as an example, in which the protrusion part 22 supports the diffuser panel 16 of the backlighting device 12 shown in FIG. 14.

In the backlighting device 12 according to the sixth embodiment, the protrusion part 22 supports the diffuser panel 16 (see FIG. 16).

When the contact area of the tip part 221 of the protrusion part 22 to the diffuser panel 16 is large, luminance unevenness (luminance unevenness caused by support) may be generated because of the support of the diffuser panel 16 by the protrusion part 22. Thus, it is desired to reduce the luminance unevenness caused by the support.

In this respect, in the backlighting device 12 according to the sixth embodiment, the tip part 221 of the protrusion part 22 is formed so as to have the shape of an acute angle, as shown in FIGS. 14 to 16. In this way, thanks to the shape of an acute angle of the tip part 221 of the protrusion part 22, it is possible to reduce the contact area of the tip part 221 of the protrusion part 22 to the diffuser panel 16. Thus, the luminance unevenness caused by the support can be reduced. In addition, in the case in which the protrusion part 22 does not support the diffuser panel 16 also, the tip part 221 of the protrusion part 22 may be formed so as to have the shape of an acute angle.

In all of the first embodiment to the sixth embodiment, the protrusion part 22 may be provided on the LED board 20, at one end and/or both ends and/or appropriately selected positions thereof. For example, the multiple protrusion parts 22 may be randomly provided on the LED board 20.

FIG. 17 is a schematic perspective view illustrating one example in which a plurality of protrusion parts 22 is randomly provided on the LED board 20 of the backlighting device 12 shown in FIG. 14.

As shown in FIG. 17, the protrusion parts 22, which are randomly provided on the LED board 20, can prevent randomly the heat shrinkage of the reflection sheet 40.

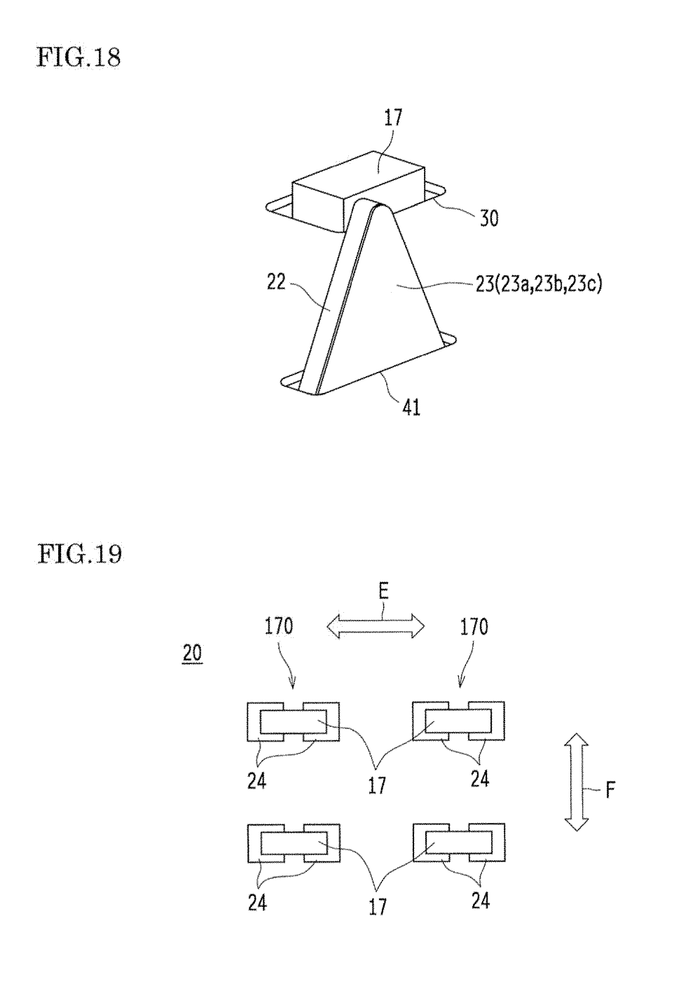

FIG. 18 is a schematic perspective view illustrating one example in which the reflection member 23 is provided on the protrusion part 22 of the backlighting device 12 shown in FIG. 14.

As shown in FIG. 18, the reflection member 23 (for example, the white resist 23a, the reflection sheet 23b and the reflection tape 23c) is provided on the protrusion part 22 (in this example, the protrusion part 22 including the tip part 221 having the shape of an acute angle). With this configuration, it is possible to improve the optical reflectance by the reflection member 23 provided on the protrusion part 22, which contributes to improvement of the efficiency in the use of the light L. In addition, in the case in which the protrusion part 22 supports the diffuser panel 16, it is also possible to effectively reduce the luminance unevenness caused by the support.

### Seventh Embodiment

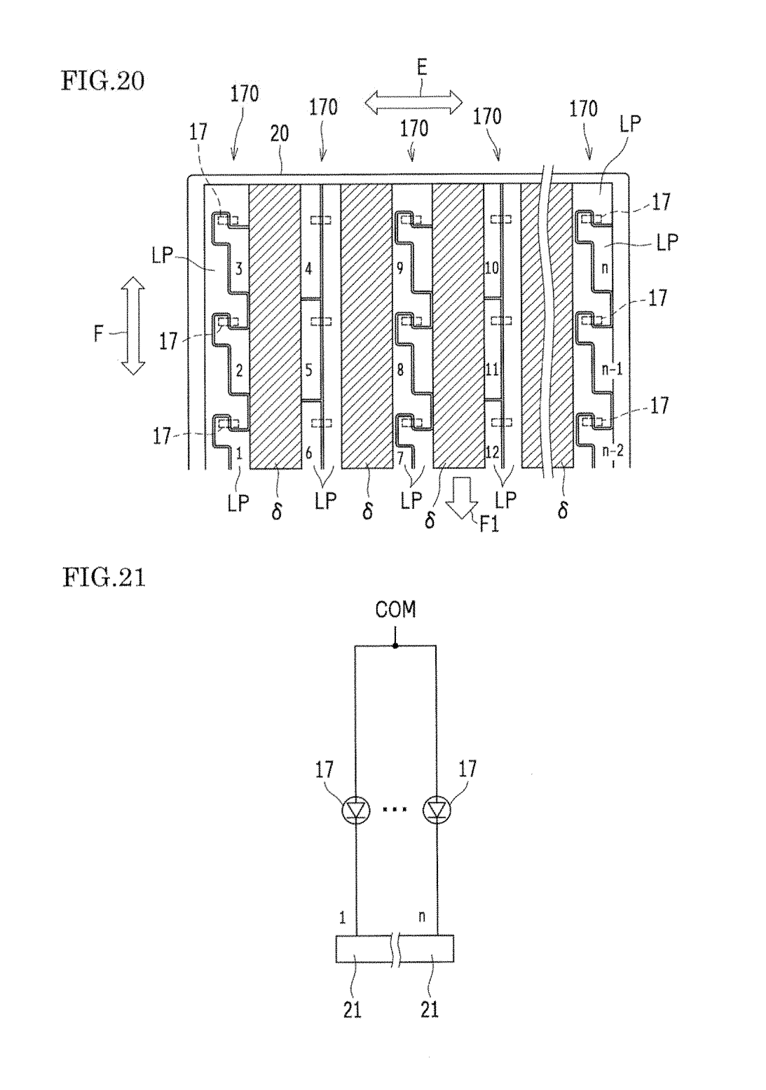

FIG. 19 is a schematic plan view illustrating a configuration in which the LEDs 17 are electrically connected to electric connection parts 24 (pads) of the LED board 20. FIG. 20 is a schematic bottom view indicating a region for providing the protrusion part 22 on the LED board 20. FIG. 21 is a circuit diagram illustrating one example of an electric circuit corresponding to a wiring pattern LP shown in FIG. 20. FIG. 22 is a schematic plan view illustrating one example of the LED board 20 including the protrusion part 22. In FIGS. 20 and 21, n indicates an integer greater than or equal to 2.

The respective wiring patterns LP of the LEDs 17 are patterned such that each wiring end part (a connection part to the connector 21) is headed toward an end of the LED board 20 in the orthogonal direction F (see FIGS. 19 and 20). The connector 21 is provided at the end of the LED board 20 in the orthogonal direction F. In each of the LEDs 17, one end is connected to a common terminal (COM) and the other end is connected to the connector 21, as shown in FIG. 21. Thus, it is possible to drive the LEDs 17 individually or for each specific region thereof. The multiple LEDs 17 are arranged along the orthogonal direction F. The respective lines of the LEDs 17 arranged in the orthogonal direction F constitute a plurality of LED arrays 170. The LED arrays 170 are lined up in the extending direction E.

The protrusion parts 22 are provided between the adjacent two LED arrays 170.

With this configuration, the protrusion parts 22 can be provided on the LED board 20, without being obstructed by the LEDs 17. In this example, the LED 17 is extended on the LED board 20 in the extending direction E in plan view. Taking into account the connection of the respective LEDs 17 whose extending direction E is the longitudinal direction to the wiring patterns LP, it is preferable that the protrusion parts 22 on the LED board 20 are formed by providing cutting and raising positions within hatched regions δ along a connection direction F1 of the connector 21 (i.e. the direction toward the connector 21), as shown in FIG. 20. It is further preferable that the cutting and raising position of the protrusion part 22 is provided at a position separated from the LED 17 by the distance of ½ H, where H represents the distance between the adjacent LEDs 17 in the extending direction E, as shown in FIG. 22.

The present invention should not he limited to the above-described embodiments and may be embodied in various other forms. Therefore, the above-described embodiments are to be considered in all respects as illustrative and not restrictive. The scope of the invention is indicated by the appended claims rather than by the foregoing description. All modifications and changes that come within the equivalency range of the appended claims are intended to be embraced therein.

What is claimed is:

1. A lighting device comprising:
a board on which a plurality of light emitting elements arranged in a matrix; and
a reflection sheet provided on the board and having a plurality of apertures, the plurality of apertures each being superimposed on a corresponding one of the plurality of light emitting elements, wherein
the reflection sheet is extended in a predetermined specific extending direction,
a protrusion part is provided on the board so as to protrude through the reflection sheet, and
the protrusion part is integrally formed with the board.

2. The lighting device according to claim 1, wherein
an insertion part is provided in the reflection sheet such that the protrusion part of the board is inserted into the insertion part.

3. The lighting device according to claim 1, wherein
the protrusion part is a bent part made by bending a part of the board.

4. The lighting device according to claim 1, further comprising a diffuser panel provided so as to face a surface of the board on which the plurality of light emitting elements is mounted, wherein
the protrusion part supports the diffuser panel.

5. The lighting device according to claim 1, wherein
a reflection member is provided on the protrusion part.

6. The lighting device according to claim 1, further comprising a diffuser panel provided so as to face a surface of the board on which the plurality of light emitting elements is mounted, wherein
a recess part is provided in the diffuser panel such that a tip part of the protrusion part is inserted into the recess part.

7. The lighting device according to claim 1, further comprising a diffuser panel provided so as to face a surface of the hoard on which the plurality of light emitting elements is mounted, wherein
a predetermined specific pattern is provided on the diffuser panel, and
a relative positional relationship between the predetermined specific pattern and the plurality of light emitting elements is maintained.

8. The lighting device according to claim 1, wherein
a tip part of the protrusion part is formed so as to have a shape of an acute angle.

9. A display device comprising the lighting device according to claim 1.
